(19) United States
(12) Patent Application Publication
(10) Pub. No.: US 2010/0263474 A1
(43) Pub. Date: Oct. 21, 2010

(54) STEERING APPARATUS

(75) Inventors: Hajime Tanaka, Aichi-ken (JP); Tomonari Yamakawa, Aichi-ken (JP)

Correspondence Address: OBLON, SPIVAK, MCCLELLAND MAIER & NEUSTADT, L.L.P., 1940 DUKE STREET, ALEXANDRIA, VA, 22314, US

(73) Assignee: TOYOTA JIDOSHA KABUSHIKI KAISHA, Toyota-shi (JP)

(21) Appl. No.: 12/808,071

(22) PCT Filed: Dec. 11, 2008
(86) PCT No.: PCT/IB2008/003414

§ 371 Date: Jun. 14, 2010

(30) Foreign Application Priority Data
Dec. 14, 2007 (JP) 2007-323539

(51) Int. Cl. B62D 1/16; B23P 11/00

(52) U.S. Cl. 74/492; 29/428; 29/525.11

(57) ABSTRACT

A steering apparatus includes: an input shaft that transmits a steering force input from a steering wheel; an output shaft that transmits a steered force by which wheels are steered; and an eccentric pin mechanism that includes an eccentric cam and an adapting plate. The output shaft is arranged at a position that is radially offset from the input shaft, and is connected to one of the eccentric cam and the adapting plate. The other one of the eccentric cam and the adapting plate is connected to the input shaft. A middle accommodation member that accommodates the eccentric pin mechanism is formed separately from an input-side accommodation member that accommodates the input shaft and an output-side accommodation member that accommodates the output shaft.

### BACKGROUND OF THE INVENTION

1. Field of the Invention

The invention relates to a steering apparatus used in a vehicle, such as a passenger car, a truck and a bus.

2. Description of the Related Art

A steering apparatus used in a vehicle, for example, includes a steering wheel, a column shaft, a torque sensor input shaft, an intermediate shaft, and a rack-and-pinion mechanism. The column shaft is rotatably supported by a column tube. The torque sensor input shaft is rotatably supported by a torque sensor housing. The above steering apparatus includes an eccentric pin mechanism that provides a variable ratio of a steering angle input from the steering wheel to a steered angle of the torque sensor input shaft, which is, for example, described in Japanese Patent Application Publication No. 3-227772 (JP-A-3-227772).

However, for applying the eccentric pin mechanism to a steering apparatus, the ratio of an offset amount b between the torque sensor input shaft and the column shaft to an offset amount a between the torque sensor input shaft and the eccentric pin, that is, the eccentricity e (=b/a), is adjusted to thereby adjust an angular transmission gear ratio to a value suitable for operability and stability that are required for each vehicle. In this case, when the offset amount b is adjusted for vehicles, it is necessary to change the shape of an output-side portion of the column tube and the shape of an input-side portion of the torque sensor housing from one vehicle to another. This problematically leads to an increase in the number of types of component.

### SUMMARY OF THE INVENTION

The invention provides a steering apparatus that is able to prevent an increase in the number of types of component.

An aspect of the invention relates to a steering apparatus that includes: an input shaft that transmits a steering force input from a steering wheel; an output shaft that transmits a steered force by which wheels are steered; and an eccentric pin mechanism that includes an eccentric cam and an adapting plate. In the above steering apparatus, the output shaft is arranged at a position that is radially offset from the input shaft, and is connected to one of the eccentric cam and the adapting plate, the other one of the eccentric cam and the adapting plate is connected to the input shaft, and a middle accommodation member that accommodates the eccentric pin mechanism is formed separately from an input-side accommodation member that accommodates the input shaft and an output-side accommodation member that accommodates the output shaft.

The output shaft may be connected to the adapting plate, and the eccentric cam may be connected to the input shaft.

The eccentric cam may have a first protrusion that protrudes toward an input side, the input shaft may have a first recess at its output side, and the first recess may be connected to the first protrusion.

The adapting plate may have a second recess that recedes from an output side toward an input side, the output shaft may have a second protrusion at its input side, and the second protrusion may be connected to the second recess.

The middle accommodation member may be screwed to the input-side accommodation member and the output-side accommodation member by bolts.

The input-side accommodation member may include a column tube that surroundingly accommodates the input shaft; and a column tube housing that surroundingly accommodates a connecting portion at which the input shaft is connected to one of the eccentric cam or the adapting plate, and the outer diameter of the middle accommodation member may be substantially equal to the outer diameter of the column tube housing.

The inner diameter of the middle accommodation member may be changed depending on a position of the output shaft that is radially offset from the input shaft.

The eccentric pin mechanism may include an eccentric pin on a surface of the adapting plate, facing the eccentric cam, and the eccentric pin may be arranged at a position that is radially offset from a central axis of the adapting plate.

An offset amount between the input shaft and the output shaft may be smaller than an offset amount between the eccentric pin and the central axis of the adapting plate.

The eccentric pin mechanism may adjust the offset amount between the input shaft and the output shaft to thereby adjust an angular transmission gear ratio that indicates the relationship between a steering angle input from the steering wheel and a steered angle output from the output shaft.

It is not necessary to change the input-side accommodation member or the output-side accommodation member from one vehicle to another, and only the middle accommodation member needs to be changed. Thus, it is possible to prevent an increase in the number of types of component from one vehicle to another.

According to the aspects of the invention, it is possible to provide a steering apparatus that is able to prevent an increase in the number of types of component.

### BRIEF DESCRIPTION OF THE DRAWINGS

The features, advantages, and technical and industrial significance of this invention will be described in the following detailed description of example embodiments of the invention with reference to the accompanying drawings, in which like numerals denote like elements, and wherein:

FIG. 1 is a schematic view that shows a steering apparatus according to an embodiment of the invention;

FIG. 2 is an enlarged schematic view of the steering apparatus shown in FIG. 1;

FIG. 3 is a schematic cross-sectional view taken along the line in FIG. 2;

FIG. 4 is another enlarged schematic view of the steering apparatus shown in FIG. 1;

FIG. 5 is a schematic cross-sectional view taken along the line V-V in FIG. 4;

FIG. 6 is a graph that shows characteristics of the steering apparatus according to the embodiment of the invention; and

FIG. 7 is a graph that shows a characteristic of the steering apparatus according to the embodiment of the invention.

### DETAILED DESCRIPTION OF EMBODIMENTS

Hereinafter, an embodiment of the invention will be described with reference to the accompanying drawings.

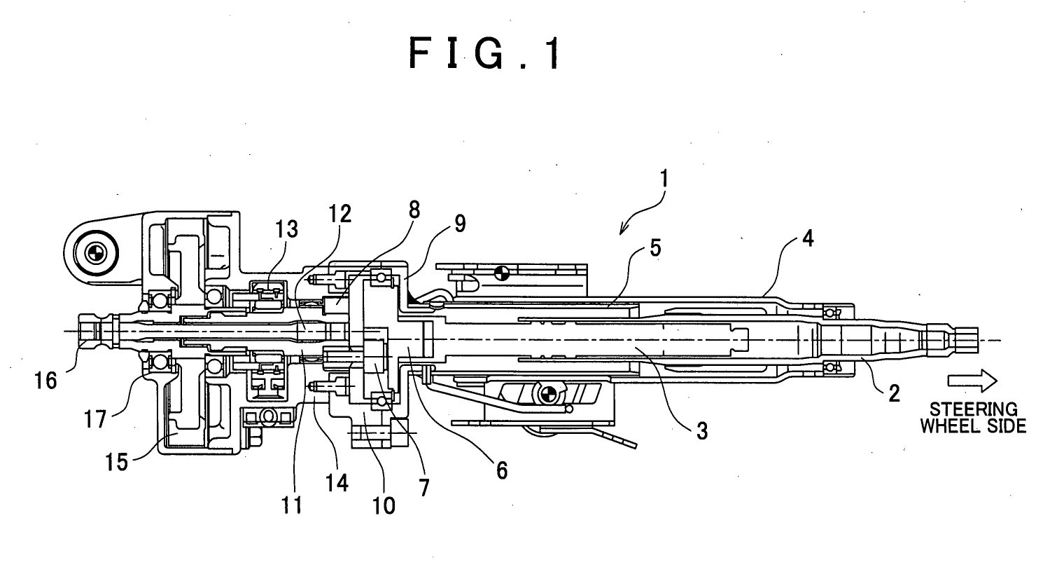

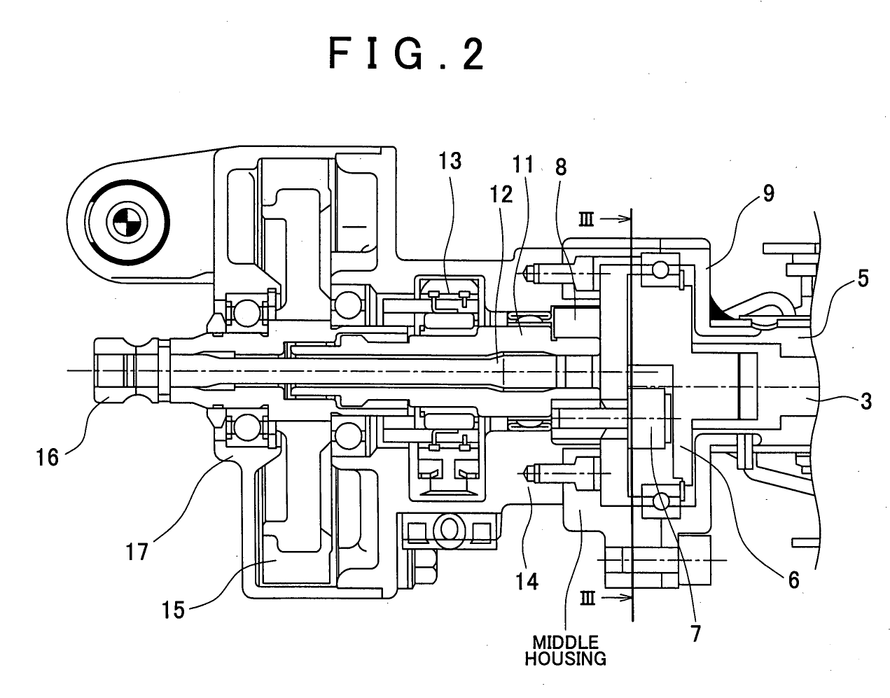

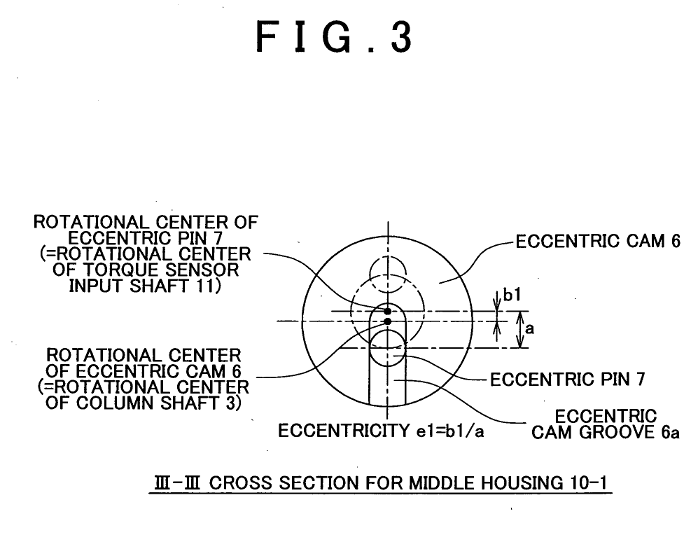

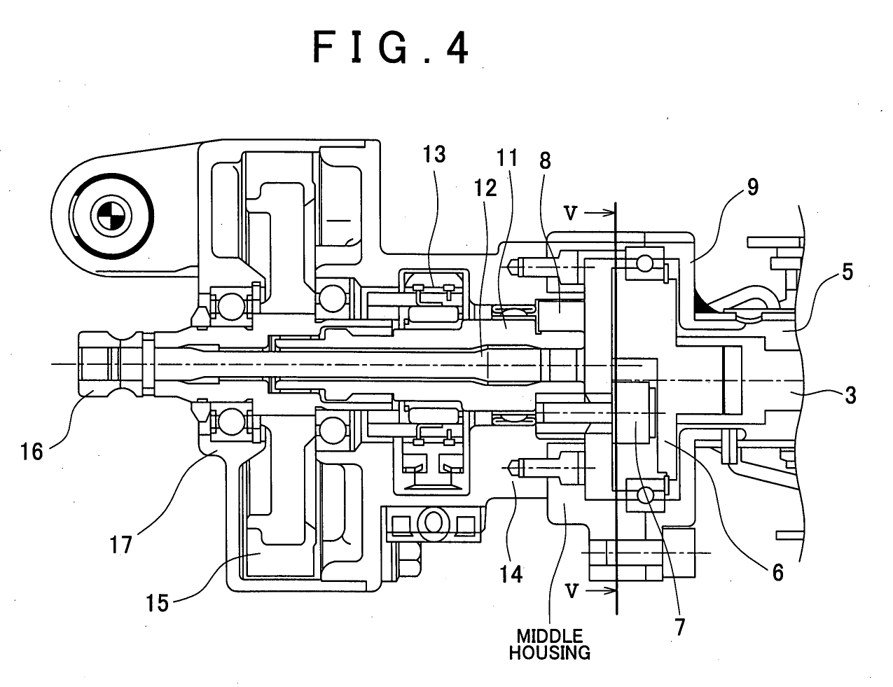

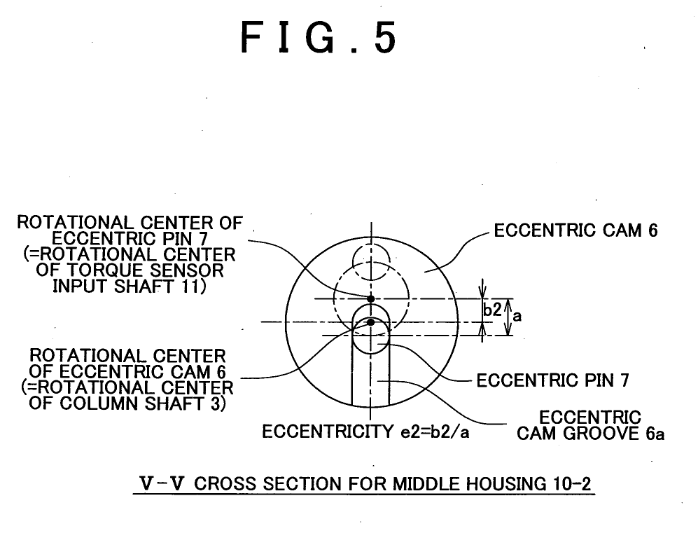

FIG. 1 is a schematic view that shows a steering apparatus according to an embodiment of the invention. FIG. 2 is an enlarged schematic view of an output side of the steering apparatus with respect to an eccentric pin mechanism. FIG. 3 is a schematic cross-sectional view that is taken along the line in FIG. 2. FIG. 4 is an enlarged schematic view of the output side of the steering apparatus with respect to the eccentric pin mechanism. FIG. 5 is a schematic cross-sectional view that is taken along the line V-V in FIG. 4.

As shown in FIG. 1, the steering apparatus 1 according to the present embodiment includes a steering wheel (not shown), a column shaft 2, a column shaft 3, an upper column tube 4, a lower column tube 5, an eccentric cam 6, an eccentric pin 7, an adapting plate 8, a column tube housing 9, a middle housing 10, a torque sensor input shaft 11, a torsion bar 12, a torque sensor 13, a torque sensor housing 14, a worm wheel 15, an electronic power steering electronic control unit (EPSECU) (not shown), a motor (not shown), a lower shaft 16, and a worn housing 17.

The input side of the column shaft 2 is coupled to the steering wheel (not shown). The output side of the column shaft 2 has a hollow cylindrical shape. The column shaft 3 is serration-fitted inside the hollow cylindrical portion of the output side of the column shaft 2 so that it is axially displaceable. This structure absorbs an axial displacement between the column shaft 2 and the column shaft 3.

The column shaft 2 transmits a driver's steering force, input from the steering wheel (not shown), to the column shaft 3. The column shaft 3 transmits the steering force, input from the column shaft 2, to the eccentric cam 6. Thus, the column shaft 3 constitutes an input shaft.

The upper column tube 4 surroundingly accommodates the column shaft 2 and also rotatably supports the column shaft 2. The lower column tube 5 surroundingly accommodates the column shaft 3 and also rotatably supports the column shaft 3.

The eccentric cam 6, the eccentric pin 7 and the adapting plate 8 are assembled together to form an eccentric pin mechanism. The eccentric cam 6 has a circular column-shaped first protrusion that protrudes toward the input side. The output side of the column shaft 3 has a closed-end cylindrical first recess to which the first protrusion can be fitted for connection. These first recess and first protrusion respectively have serrations (not shown) or keys. By fitting the first protrusion into the first recess for connection, the eccentric cam 6 is coaxially connected to the output side of the column shaft 3.

The output side of the adapting plate 8 has a cylindrical second recess that recedes from the output side toward the input side. The input side of the torque sensor input shaft 11, which serves as an output shaft, has a circular column-shaped second protrusion that protrudes toward the input side. The second protrusion can be fitted into the second recess for connection.

These second recess and second protrusion respectively have serrations (not shown) or keys. By fitting the second protrusion into the second recess for connection, the torque sensor input shaft 11, which serves as the output shaft, is coaxially connected to the adapting plate 8.

The disc-shaped eccentric cam 6 is rotatably supported at its outer peripheral surface by the column tube housing 9 and the middle housing 10 through a bearing. A cylindrical portion is provided at an input side, which is the right-hand side in FIG. 1, of the column tube housing 9 so as to protrude toward the input side. The lower column tube 5 is connected onto the outer peripheral surface of the cylindrical portion by crimping.

A bearing surface portion is provided at an output side of the column tube housing 9 on an outer peripheral surface at a position at which the column shaft 3 is offset by a first offset amount b from the torque sensor input shaft 11. The bearing surface portion is used to connect the middle housing 10 with the column tube housing 9 by screwing a bolt into an internal thread formed in the middle housing 10. The column tube housing 9 and the lower column tube 5 cooperatively constitute an input-side accommodation member that accommodates the column shaft 3.

Furthermore, a fixed portion is provided at an output side of the middle housing 10 at a portion that axially faces the torque sensor housing 14. The fixed portion is used to connect the middle housing 10 with the torque sensor housing 14 by screwing bolts into a plurality of internal threads formed in the torque sensor housing 14. The middle housing 10 constitutes a middle accommodation member that accommodates the eccentric cam 6, the eccentric pin 7 and the adapting plate 8. The eccentric cam 6, the eccentric pin 7 and the adapting plate 8 constitute the eccentric pin mechanism.

The torque sensor housing 14 has a hollow cylindrical shape. The torque sensor housing 14 constitutes an output-side accommodation member that accommodates the torque sensor input shaft 11 and the torque sensor 13.

The torque sensor input shaft 11 has a hollow cylindrical shape. The input side of the torsion bar 12 is drivably serration-connected or key-connected to the inner peripheral surface of the input side of the torque sensor input shaft 11. Similarly, the output side of the torsion bar 12 is drivably serration-connected or key-connected to the inner peripheral side of the hollow cylindrical lower shaft 16.

The torque sensor input shaft 11 is arranged at a position that is radially offset by the first offset amount b from the column shaft 3. In addition, the torque sensor input shaft 11 is drivably connected to the lower shaft 16 by the torsion bar 12 so that it is circumferentially displaceable. The worm wheel 15 is drivably connected to the lower shaft 16. The input side of the lower shaft 16 with respect to the worm wheel 15 is rotatably supported by the torque sensor housing 14 through a bearing. The output side of the lower shaft 16 with respect to the worm wheel 15 is rotatably supported by the worm housing 17 through a bearing.

The torque sensor 13 detects a driver's steering force, input from the steering wheel, corresponding to a relative displacement with respect to the lower shaft 16 of the torque sensor input shaft 11, and outputs the detected steering force to the EPSECU.

The EPSECU, for example, includes a CPU, a ROM, a RAM and a data bus that connects them with one another. In accordance with a program stored in the ROM, the CPU executes a process described below.

The EPSECU controls driving of the motor for generating an assist force on the basis of the steering force detected by the torque sensor 13. A driving force generated by the motor drives the worm wheel 15 and is then transmitted to the lower shaft 16. That is, the EPSECU, the motor and the worm wheel 15 generate an assist force on the basis of a torque detected by the torque sensor 13, that is, a steering force.

Although not shown in the drawing here, the output side of the lower shaft 16 is drivably connected to a pinion of the rack-and-pinion mechanism through the intermediate shaft. When a driver's steering force is input from the steering wheel, an assist force that is proportional to the steering force is generated at the motor by the control of the EPSECU. The assist force is transmitted through the worm wheel 15 to the lower shaft 16, the intermediate shaft, and the pinion of the rack-and-pinion mechanism. As a result, a rack bar is moved in the width direction of a vehicle, and then a tie rod, coupled to the rack bar at the outer sides in the width direction, steers wheels (not shown).

A surface of the eccentric cam 6, facing the adapting plate 8, has an eccentric cam groove 6a that extends in the diameter direction. The eccentric pin 7 provided on the adapting plate 8 is slidably fitted in the eccentric cam groove 6a. The central axis of the eccentric cam 6 is offset by the first offset amount b from the central axis of the adapting plate 8.

The eccentric pin 7 is rotatably provided on the surface of the adapting plate 8, facing the eccentric cam 6, at a position at which the central axis of the eccentric pin 7 is offset by a second offset amount a, which is larger than the first offset amount b, from the central axis of the adapting plate 8. The eccentric pin 7 and the eccentric cam groove 6a of the eccentric cam 6 provide a variable ratio of a steering angle of the column shaft 3, which serves as the input shaft, to a steered angle of the torque sensor input shaft 11, which serves as the output shaft. Note that the detailed structure is similar to that described in JP-A-3-227772, so the detailed description is omitted.

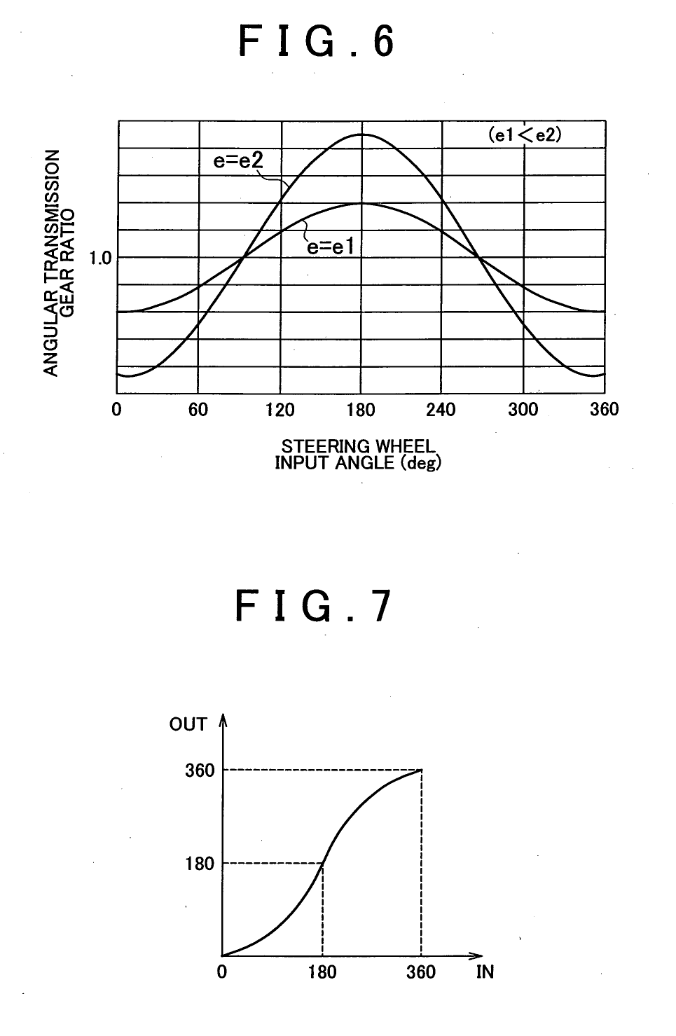

The thus configured eccentric pin mechanism is able to adjust an angular transmission gear ratio that indicates how a steered angle of the lower shaft 16 or the torque sensor input shaft 11 varies against a steering angle input from the steering wheel by adjusting the first offset amount b to adjust the eccentricity e (=b/a). This will be described with reference to the accompanying drawings below. FIG. 6 and FIG. 7 are graphs that show input/output characteristics of the steering apparatus according to the embodiment of the invention.

For example, when the first offset amount b is set to b1 as shown in FIG. 2 and FIG. 3, the eccentricity e1 is equal to b1/a, whereas when the first offset amount b is set to b2 (b2>b1) as shown in FIG. 4 and FIG. 5, the eccentricity e2 is equal to b2/a. Thus, e2 is larger than e1. In this manner, by varying the eccentricity, it is possible to vary the characteristic of the angular transmission gear ratio as shown in FIG. 6. Note that the angular transmission gear ratio is obtained by calculating differentiating the relationship, shown in FIG. 7, between a steered angle of an output side (OUT) and a steering angle of an input side (IN), which is equal to a steering wheel input angle.

As shown in FIG. 2 and FIG. 4, the first offset amount b, that is, a distance between the rotational center of the torque sensor input shaft 11 and the rotational center of the column shaft 3, is varied to change the characteristic of the angular transmission gear ratio. In order to vary the first offset amount b, the disc-shaped eccentric cam 6 needs to be shifted radially with respect to the torque sensor input shaft 11. Therefore, if the eccentric cam 6 is formed as in the case of the related art so that the shape of the output side portion of the column tube housing 9 and the shape of the input side portion of the torque sensor housing 14 are changed from one vehicle to another, it problematically leads to an increase in the number of types of the column tube housing 9 and/or the torque sensor housing 14.

Then, as in the case of the steering apparatus 1 according to the present embodiment described above, when the middle housing 10 that surroundingly accommodates the eccentric pin mechanism is provided separately from the column tube housing 9 and the torque sensor housing 14, the following function and advantageous effects may be obtained. That is, it is not necessary to change the column tube housing 9 and the lower column tube 5, which serve as the input-side accommodation member, and the torque sensor housing 14, which serves as the output-side accommodation member, from one vehicle to another in conformity with changes in the first offset amount b, and only the middle housing 10, which serves as the middle accommodation member, needs to be changed. Thus, it is possible to prevent an increase in the number of types of component from one vehicle to another.

That is, as shown in FIG. 2, when the first offset amount is b1, a middle housing 10-1 is applied so as to be able to surroundingly accommodate the eccentric cam 6 that is radially offset by the first offset amount b1 from the torque sensor input shaft 11, whereas as shown in FIG. 4, when the first offset amount is b2, a middle housing 10-2 is applied so as to be able to surroundingly accommodate the eccentric cam 6 that is radially offset by the first offset amount b2 from the torque sensor input shaft 11.

Note that in the present embodiment, portion of the middle housing 10, which surroundingly accommodates the eccentric cam 6, has a cylindrical shape. The outer diameter of the cylindrical outer peripheral portion is the same between the middle housing 10-1 and the middle housing 10-2. However, the inner diameter of the cylindrical outer peripheral portion is different between the middle housing 10-1 and the middle housing 10-2. The inner diameters of the cylindrical outer peripheral portions are formed so as to correspond to the respective first offset amounts b1 and b2. In other words, in the present embodiment, by adjusting the thickness in the radial direction of the middle housing (thickness in a direction perpendicular to the axial direction) in accordance with the first offset amount b, the middle housing may be connected to the column tube housing 9 and the torque sensor housing 14 and may surroundingly accommodate any of the eccentric cams 6 having different first offset amounts b. Therefore, it is not necessary to change the column tube housing 9 and the lower column tube 5, which serve as the input-side accommodation member, and the torque sensor housing 14, which serves as the output-side accommodation member, from one vehicle to another in accordance with changes in the first offset amount b, and only the middle housing 10, which serves as the middle accommodation member, needs to be changed. Thus, it is possible to prevent an increase in the number of types of component from one vehicle to another.

With the thus configured steering apparatus 1, even when the angular transmission gear ratio of the eccentric pin mechanism is varied from one vehicle to another, only the middle housing 10 needs to be changed, and the column shaft 3, the column shaft 2 and the torque sensor input shaft 11 may be made common among different vehicles.

Furthermore, components, other than the column shaft 3 and the torque sensor input shaft 11, such as the steering wheel (not shown), the column shaft 2, the upper column tube 4, the eccentric cam 6, the eccentric pin 7, the adapting plate 8, the torsion bar 12, the torque sensor 13, the worm wheel 15, the EPSECU (not shown), the motor (not shown), the lower shaft 16 and the worm housing 17, may also be made common among different vehicles.

The embodiment of the invention is described in detail above; however, the aspects of the invention are not limited to the above described embodiment. Various modifications or replacements may be added to the above described embodiment without departing from the scope of the invention.

For example, in the above described steering apparatus 1, the middle housing 10 is connected through the column tube housing 9 to the lower column tube 5 that accommodates the column shaft 3. Instead, a flange portion may be directly formed on the lower column tube 5, and the middle housing 10 may be directly connected to the flange portion.

Furthermore, the steering apparatus according to the aspects of the invention may be applied to any types, such as a column assist type, a pinion assist type and a rack assist type, and it may also be applied to a type equipped with a hydraulic power multiplying device.

The aspects of the invention relate to a steering apparatus for a vehicle, and make it possible to provide a steering apparatus that prevents an increase in the number of types of component with a relatively simple structure and slight changes. Thus, the aspects of the invention are advantageous when applied to steering apparatuses for various vehicles, such as regular passenger cars, trucks, and buses, and assembling of a steering apparatus to a vehicle.

1. A method for assembling a steering apparatus with a variable angular transmission gear ratio, said steering apparatus comprising:
an input shaft that transmits a steering force input from a steering wheel;
an output shaft that transmits a steered force by which wheels are steered;
an input-side accommodation member that accommodates the input shaft;
an output-side accommodation member that accommodates the output shaft; and
an eccentric pin mechanism that includes an eccentric cam and an adapting plate, wherein
the output shaft is arranged at a position that is radially offset from the input shaft, and is connected to one of the eccentric cam and the adapting plate, and
the other one of the eccentric cam and the adapting plate is connected to the input shaft, and
the method comprising:
adjusting an angular transmission gear ratio of the steering apparatus by changing an offset amount between the rotational center of the output shaft and the rotational center of the input shaft;
selecting a middle accommodation member that accommodates the eccentric pin mechanism and that is formed separately from the input-side accommodation member and the output-side accommodation member in accordance with the offset amount; and
connecting the selected accommodation member with the input-side accommodation member and the output-side accommodation member.

2. The method according to claim 1, further comprising:
changing the angular transmission gear ratio of the steering apparatus by changing the offset amount between the rotational center of the output shaft and the rotational center of the input shaft; and
changing only the middle accommodation member in conformity with changes in the offset amount.

3. The method according to claim 1, further comprising:
connecting the output shaft to the adapting plate, and
connecting the eccentric cam to the input shaft.

4. The method according to claim 3, wherein the eccentric cam has a first protrusion that protrudes toward an input side, and the input shaft has a first recess at its output side, further comprising:
connecting the first recess to the first protrusion.

5. The method according to claim 3, wherein the adapting plate has a second recess that recedes from an output side toward an input side, and the output shaft has a second protrusion at its input side, further comprising:
connecting the second protrusion to the second recess.

6. The method according to claim 1, further comprising:
screwing the middle accommodation member to the input-side accommodation member and the output-side accommodation member by bolts.

7. The method according to claim 1, further comprising:
changing the inner diameter of the middle accommodation member depending on a position of the output shaft that is radially offset from the input shaft.

8. The method according to claim 1, wherein
the eccentric pin mechanism includes an eccentric pin on a surface of the adapting plate, facing the eccentric cam, further comprising:
arranging the eccentric pin at a position that is radially offset from a central axis of the adapting plate.

9. The method according to claim 8, further comprising:
setting an offset amount between the input shaft and the output shaft smaller than an offset amount between the eccentric pin and the central axis of the adapting plate.

10. The method according to claim 9, further comprising:
adjusting the offset amount between the input shaft and the output shaft to thereby adjust an angular transmission gear ratio that indicates the relationship between a steering angle input from the steering wheel and a steered angle output from the output shaft.

11. A steering apparatus for carrying out the method according to claim 1, comprising:
an input shaft that transmits a steering force input from a steering wheel;
an output shaft that transmits a steered force by which wheels are steered; and
an eccentric pin mechanism that includes an eccentric cam and an adapting plate, wherein
the output shaft is arranged at a position that is radially offset from the input shaft, and is connected to one of the eccentric cam and the adapting plate,
the other one of the eccentric cam and the adapting plate is connected to the input shaft, and
a middle accommodation member that accommodates the eccentric pin mechanism and that is formed separately from an input-side accommodation member that accommodates the input shaft and an output-side accommodation member that accommodates the output shaft and that is formed in accordance with the offset amount between the rotational center of the output shaft and the rotational center of the input shaft.

12. The steering apparatus according to claim 11, wherein
the input-side accommodation member includes a column tube that surroundingly accommodates the input shaft; and a column tube housing that surroundingly accommodates a connecting portion at which the input shaft is connected to one of the eccentric cam or the adapting plate, and
the outer diameter of the middle accommodation member is substantially equal to the outer diameter of the column tube housing.
